(19) United States
(12) Patent Application Publication
(10) Pub. No.: US 2015/0048220 A1
(43) Pub. Date: Feb. 19, 2015

(54) Cable Clip

(71) Applicant: Colin Patterson, West Lothian (GB)

(72) Inventor: Colin Patterson, West Lothian (GB)

(21) Appl. No.: 14/385,188

(22) PCT Filed: Mar. 11, 2013
(86) PCT No.: PCT/GB2013/050591

§ 371 Date: Sep. 15, 2014

(30) Foreign Application Priority Data
Mar. 13, 2012 (GB) 1204444.2

(51) Int. Cl. H02G 3/32; F16L 3/04

(52) U.S. Cl. CPC H02G 3/32; F16L 3/04
USPC 248/68.1; 248/71

(57) ABSTRACT

A cable clip having a body providing a cable receiving portion at one end thereof and a pin extending away from the longitudinal axis of the body. The cable receiving portion is v-shaped in cross-section, and the open side of the v-shaped section extends in a direction of the pin.

### FIELD OF THE INVENTION

The present invention relates to a cable clip or more particularly a cable clip for affixing wires, cables, leads or other elongate parts to a structure.

### BACKGROUND

Increasing willingness to improve home and business premises coincides with increasing concern in relation to electrical safety and corresponding legislation.

Increasingly also many new improvements are underway in electrical fields such as more lighting, better connectivity and increased home appliances and electrical apparatus.

This means that frequently wiring in many situations or premises is replaced by electricians or even unskilled workers. Even where a qualified electrician is working, in many situations the working conditions are tight and unsatisfactory and the worker will encounter a multitude of problems.

A particular problem the typical worker will encounter is the problem of securing cables or wires to walls or surfaces. Where the wire will need to be held on the surface typically plastic clip is used, composed of an arcuate section and flat section having at least one hole the user will attempt to hammer a nail through the hole, whist holding the wire within the arcuate section.

The problems with this are that typically the wire will twist, flex or bend out of position from the arcuate, meaning that the flat section is not correctly presented to the surface. Moreover the nail will then be likely to move within the hole meaning that the nail is also or furthermore not correctly presented.

The pin will then be manoeuvred with some difficulty back into a correct position, but as the nail is loose it is frequently the case that during manoeuvring of the clip the nail will fall out, the clip will fall or the cable will escape the arcuate section again.

All of this will be further compounded by the need for the user to hold or maintain closely a hammer for securing the nails. In addition frequently a half hammered pin will become dislodged during manoeuvring of the clip.

In particular when attempting to fit for example an aerial wire along a skirting board in a carpeted room the user will need to get down on hands and knees and attempt to hold the wire in place as well as the clip, pins and the hammer. The tight angles involved mean that frequently when hammering the user will find himself/herself bouncing off the carpet or skirting board, further dislodging the nail, clip or wire.

### PRIOR ART

Accordingly patent applications have been filed in the past in effort to deal with this problem, including the following:

United States patent application US 2011 031 356 (VONADA) discloses a fastener for holding an elongated member to as supporting surface, said fastener comprising a elongated body extending between a lower surface and an upper surface, said body having bottom surface, said body including a head portion and a toe portion, said head portion being connected to said toe portion by neck having a holding surface, at least a portion of said holding surface being arcuate said bottom surface, being interrupted by a holding area between the head portion and the toe portion, said holding area being located adjacent said neck, said head portion including structure defining a hole extending through said head portion said hole extending through said body substantially perpendicular to a plane extending along said bottom, and being seized and configured to receive a fastener therethrough, said bottom surface extending along said head portion a length X and extending along said toe portion a length D, said body further including a top surface, the body having a height H, said holding area having a length 2r between said head portion and said toe portion, wherein length X is at least twice length D, length X is greater than 2r, and length X is greater than height H.

Granted European patent EP 1864 025 (GAUTHIER et al) discloses an assembly formed, on the one hand, by a base plate for fastening a component to substrate, including means for receiving a fastening plug and support means intended to be applied to the component to be fastened and, on the other hand, by a fastening plug comprising a shank and a head, the means for receiving the fastening plug comprising a conduit, following compression by the head of the plug having a larger diameter than the conduit, and the head of the plug are intended to be housed once the plug has been driven through the base plate caricaturised in that the cup made of elastic material and the conduit are designed in such a manner that the cooperation between the plug shank and the conduit when the plug is driven through the base plate leads the cup to at least partially cover the head of the plug.

Granted United Kingdom patent GB 2 406 355 (DUDNEY) disclose a combination of a piece of wood and a clip which is secured to the piece of wood and which fixes pipes, cables or wires. In a position on a surface of the piece of wood; the piece of wood being such as it is a thin piece of wood; and clip being such that is comprises a holding portion which pipes cables or wires and fixing means which secures the clip to the piece of wood.

United kingdom patent application GB 894 867 (LEOOEF) discloses a clip for receiving an electrical cable or like article, a body of resilient material having two limbs for gripping the cable or like article between them and an intermediate portion interconnecting the limbs and having a centrally disposed hole through which a fastener such as a screw, nail or the like can be passed to fix the clip to the supporting surface, that surface of the intermediate portion which is adjacent the supporting surface when the clip is fixed there on being so formed that before the fastener is driven home, solely the edges of said intermediate portion which extend axially of the clip above the supporting surface, the limbs being urged towards one another as the fastener is driven home to exert force upon the cable or like article dependent upon the resilience of the clip material, until at least a portion of the said surface of the intermediate portion surrounding the hole is also brought into engagement with the supporting surface.

In contrast the present invention provides a simple effective means of securing cables, wires, etc, removing the need for three hands when making secure.

Swiss patent number 150427 describes a cable clip where the part that holds the cable is curved and the two legs that engage with a surface are pressed out of the metal from which the clip is formed.

U.S. Pat. No. 4,845,913 describes a cable holding strap, the end of which is curved and which includes a nailing prong pressed from the metal from which the strap is made.

### SUMMARY OF THE INVENTION

According to the present invention there is provided a cable clip with a plate having a curved cable grip section and at least one integrated pin.

Preferred embodiments of the clip are therefore fully constructed in metal, such as a recycled metal. This may be a single casting or may more likely be single formed plate with a plurality of pins welded thereon.

In preferred embodiments these pins have pin shanks that may be serrated, ribbed or otherwise corrugated so as to increase their effectiveness in restraining the clip from removal along a reversed removal axis one inserted along a first axis.

In typical embodiments the pin heads are inset and welded onto the plate however embodiments may be envisaged wherein the pin shanks may be restrained within. But slidably moveable with regards to, the plate.

Some embodiments may have raised or lower areas of projections that may serve to help to hammer the clip onto a surface in order that the cable being gripped, and/or curved grip section, ensuring that these are not damaged by erroneous hammering the grip section.

Further embodiments may have reinforced grip sections such that damage to the section is less likely.

Further embodiments may have padded curves, interfaces with a cable or wire.

Yet further embodiments may have an intended or reversed section wherein the plate provides an indent into which the cable with fit in use. In this way damage to the cable or section is unlikely.

In such embodiments it may be preferable that the plate and the pins are encased in plastic such as ABS with some embodiments having internal strengthening means such as for example a bar of metal or steel between the pin heads or shanks, such that for instance forming a stable format within the plastic body.

In these examples the section may be formed from plastic body. Such embodiments may have a depression for a thumb centrally or appropriately located.

Further heavier duty embodiments may be constructed in metal, fibre or alloy.

The preferred embodiments may be constructed with two pins, side by side in order to prevent rotation. Further embodiments have three or more.

Preferably the pins(s) are formed with a thin diameter and have sharp tapering to their points or tips. Such points may be toughened.

Ideally therefore in use a user would place the gripped section over a cable, tube, lead or wire (used interchangeably herein) so as to secure the cable to a surface.

The clip would then be pushed into the surface such that the pin(s) would enter into the surface in a matter such to hold the clip in place.

Some embodiments may have open through holes as well as pins so as to allow a user to also or additionally use screws for attachment to surfaces.

The invention has been described by the way of examples only and it will be appreciated that variation may be made to the above-mentioned embodiments without departing from the scope of invention.

According to another aspect of the invention there is provided a cable clip comprising a body providing a cable receiving portion at one end thereof and a pin extending away from the longitudinal axis of the body, wherein the cable receiving portion is v-shaped in cross-section, and wherein the open side of the v-shaped section extends in a direction of the pin.

The included angle of the v-shaped cable receiving portion is preferably obtuse.

Preferably, the pin extends substantially perpendicular to the longitudinal axis of the body.

Advantageously, the body includes a domed portion, the pin extending from the centre of the dome.

The cable clip may be formed of metal.

The body may be pressed from a single piece of metal. The pin may be welded to the body.

The body may be formed of plastics material. The pin may be metal and may be moulded into the body during manufacture.

According to another aspect of the invention there is provided a cable clip comprising a body providing a cable receiving portion at one end thereof and a pin extending away from the longitudinal axis of the body, wherein the body includes a domed portion, the pin extending from the centre of the dome.

The whole cable clip may be formed of plastics material.

With respect to the above descript ion then, it is to be realised that the optimum dimension relationships for the parts of the invention, to include variations in size, materials, shape, form, function, and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, falling within the scope of invention.

### BRIEF DESCRIPTION OF FIGURES

FIG. 1 shows a schematic representation and a side view of a preferred embodiment of the invention;

FIG. 2 shows a schematic representation and a side view of the embodiment illustrated in FIG. 1, with the apex of the v-shaped grip portion set at different angles;

FIG. 3a is side view of a further embodiment of the invention;

FIG. 3b is a plan view of the embodiment illustrated in FIG. 7a;

FIG. 3c is a side view of the embodiment illustrated in FIGS. 7a and 7b in use

FIGS. 4a to 4f illustrate perspective, end, side and plan views of an alternative embodiment of the invention;

FIG. 5 illustrates a further embodiment of the invention; and

FIG. 6 illustrates another further embodiment of the invention.

### DETAILED DESCRIPTION OF FIGURES

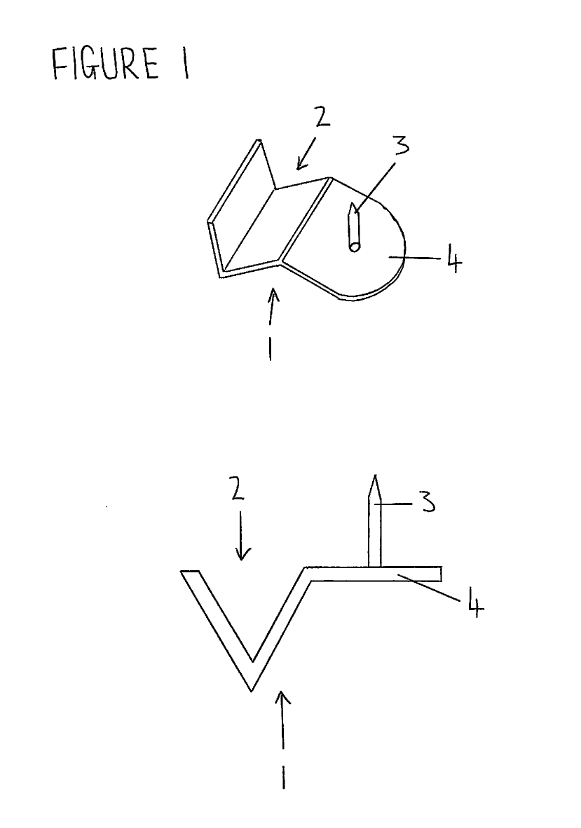

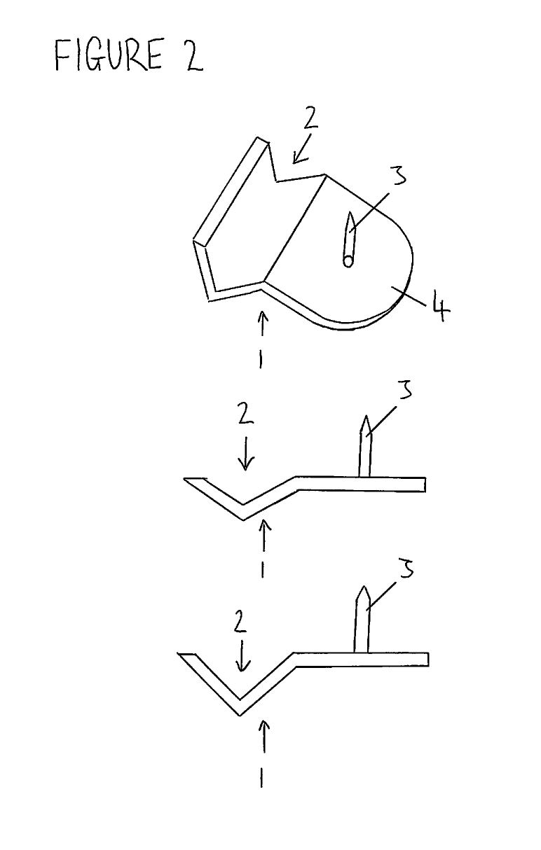

The embodiments shown in FIGS. 1 and 2a clip 1 having a grip portion 1 with a V shaped profile to permit a user to insert the pin into a fold between for example a carpet and skirting board such that the lower V face of the clip may be inserted or pivoted progressively into the fold, further helping to hold the clip in place.

This allows a user to ensure that the clip will be somewhat hidden and in attachment should be at least partly held in place as the user hammers or pushes it in.

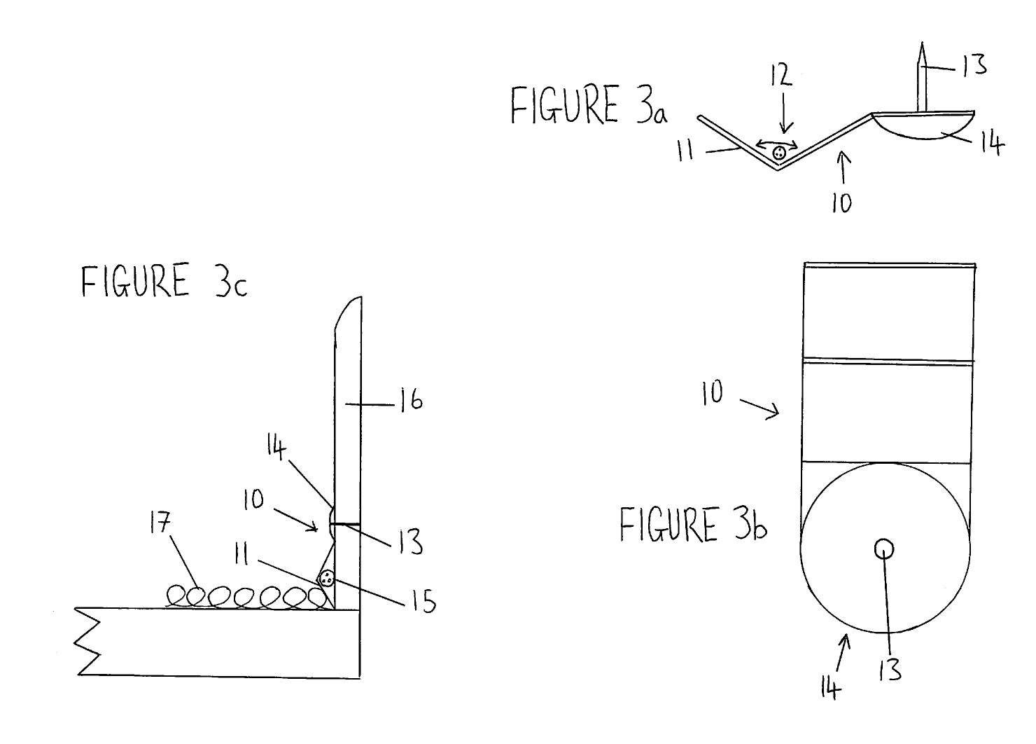

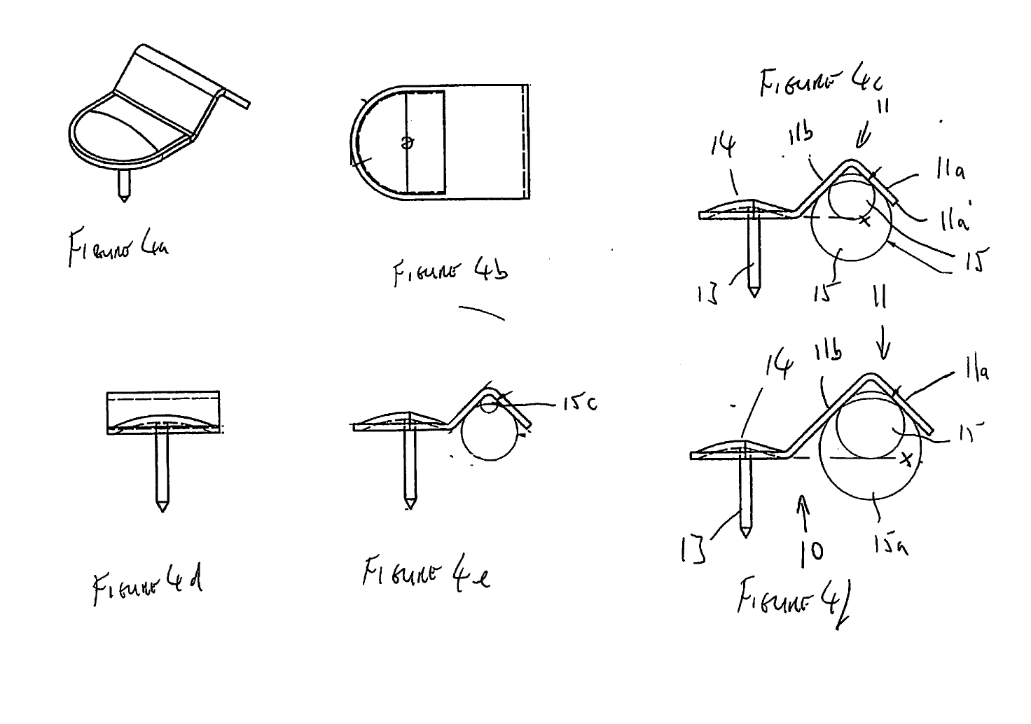

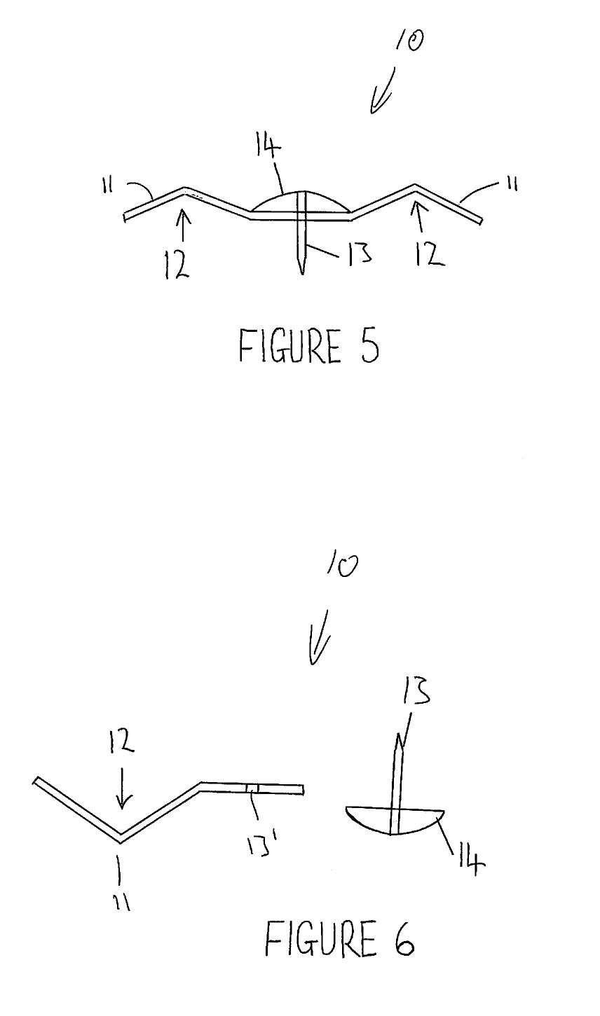

FIGS. 3a to 3c illustrate another embodiment of the invention. The cable clip 10 comprises a body including a cable grip portion 11 and pin 13 extending from a domed portion 14 of the body. The domed portion 14 contributes to the strength of the clip 10 in the region of the pin 13. The cable clip 10 may be used in the manner of a drawing pin. The domed portion 14 assists in directing the force exerted thereon by a user along the axis of the pin 13.

The cable grip portion 11 is v shaped in cross-section with the open side 12 of the v facing in the same direction as the free end of the pin 13. It can be seen from FIG. 7a that the included angle θ is obtuse and approximately 120 degrees. The reason for so forming the v-shape grip portion is explained in relation to FIG. 7c.

Whilst the clip 10 may be used in many applications, it is particularly useful for laying telephone wires. As can be seen from FIG. 3c, a telephone wire 15 is secured against a skirting board 16 only fractionally above the level of the surface of a carpet 17. The obtuse angle θ allows the free end of the cable grip portion 11 to be inserted between the surface of the skirting board and the edge of the carpet.

In use the workman or DIYer simply lays out the cable, takes a number of cable clips 10 and one at a time places the cable grip portion 11 over the cable, pushes the grip portion 11 between the skirting and carpet and presses the pin 13 into the skirting board 16. All this can be done without the need for tools.

Of course larger versions may be formed and may require a hammer to knock the pin into the wood, or the material into which the pin 13 is to be inserted may be particularly hard and therefore a hammer may be required.

FIGS. 4a to 4d illustrate an alternative embodiment of the clip 10. The cable grip portion 11 is v-shaped. The grip portion 11 has two sides 11a, 11b. The side 11a is shorter than the side 11b. Hence, the free edge 11a′ of the side 11a lies above the plane x-x of the underside of the domed portion 14. The grip portion 11 and preferably the whole clip 10, is formed of a resilient material, for example a metal such as brass or steel.

The feature of the side 11a being shorter than the side 11b and the clip being made of a resilient material each enable different sized cables to be held in the grip portion 11 to secure cables of differing diameters. Incorporating both these features into a clip further enhances the range of sizes of cable which may be secured by the clip. FIGS. 4c, 4e and 4f each show different sizes of cable 15, 15a held in the grip portion. Referring to FIGS. 4c and 4f, it can be seen that the underside of the cable 15 lies on the plane x-x, that is when the pin 13 is pressed into a skirting board, the underside of the domed portion 14 and the underside of the cable 15 will both engage the surface of the skirting board.

When the clip 10 is used to attach a larger diameter cable to an object such as a skirting board, when the pin 13 is pressed into the skirting, the resilience of the clip 10 allows the free edge 11a′ of the side 11a to be lifted away from the plane x-x, thereby allowing a larger diameter cable to be gripped by the same clip 10.I

The dome shape of the domed portion is preferably stamped into the material from which the clip 10 is formed.

The pin 13 is preferably attached the dome using the same technique as used in drawing pins to attach the pin to the head 14.

Alternatively, the pin may be pressed out of the head 14.

Referring now to FIG. 5, there is shown a clip 10 providing two grip portions 11, one to either side of the pin 13, which itself extends from domed portion 14.

FIG. 6 illustrates yet another embodiment of the cable clip 10 of the invention in which the pin 13 and domed head 14 are comprised in one part, namely a drawing pin, and the grip portion 11 is comprised in another part. The grip portion 11 includes a pin receiving hole 13′. To use the cable grip 10 the open side 12 of the grip portion is placed over a cable, and the grip portion 11 presented up to a surface, such as that of a skirting board. The pin 13 is aligned with hole 13′. The user presses on the domed portion 14 to press the pin 13 into the surface thereby securing the cable to the surface with the cable grip 10.

1. A cable clip comprising a body providing a cable receiving portion at one end thereof and a pin extending away from the longitudinal axis of the body, wherein the body includes a domed portion, the pin extending from the centre of the dome, wherein the pin is fixed to the dome.

2. A cable clip according to claim 18, wherein the included angle of the v-shaped cable receiving portion is obtuse.

3. A cable clip according to claim 1, wherein the pin extends substantially perpendicular to the longitudinal axis of the body.

4. (canceled)

5. A cable clip according to claim 18, wherein the v-shaped cable receiving portion is formed by two sides, and wherein the side distal from the pin is shorter than the side proximate the pin.

6. (canceled)

7. A clip according to claim 1, wherein the body in the region of and on the opposite side to the pin is padded.

8. A cable clip according to claim 1, formed of metal.

9. A cable clip according to claim 1, wherein the body is pressed from a single piece of metal.

10. A cable clip according to claim 1, wherein the material from which the body is formed is resilient.

11. A cable clip according to claim 1, comprising two cable receiving portions.

12. A cable clip according to claim 10, wherein the two cable receiving portions are situated to either side of the pin.

13. (canceled)

14. A cable clip according to claim 1, wherein the pin is welded to the body.

15. A cable clip according to claim 1, wherein the body is formed of plastics material.

16. A cable clip according to claim 13, wherein the pin is formed of metal and is moulded into the body during manufacture.

17. (canceled)

18. A cable clip according to claim 1, wherein the cable receiving portion is v-shaped in cross-section, and wherein the open side of the v-shaped section extends in a direction of the pin.
